(19) United States
(12) Patent Application Publication
(10) Pub. No.: US 2015/0199632 A1
(43) Pub. Date: Jul. 16, 2015

(54) METHOD AND SYSTEM FOR RECOMMENDING MOBILE TASKS TO CROWD WORKERS

(71) Applicant: Xerox Corporation, Norwalk, CT (US)

(72) Inventors: Deepthi Chander, Cochin (IN); Laura Elisa Celis, Redmond, WA (US); Koustuv Dasgupta, Bangalore (IN); Nischal Murthy Piratla, Fremont, CA (US); Chithralekha Balamurugan, Pondicherry (IN)

(73) Assignee: Xerox Corporation, Norwalk, CT (US)

(21) Appl. No.: 14/155,796

(22) Filed: Jan. 15, 2014

(51) Int. Cl. G06Q 10/06

(52) U.S. Cl. CPC G06Q 10/06311; G06Q 10/06316

(57) ABSTRACT

A method of administering mobile crowdsourcing includes: receiving a plurality of requests from requestors to fulfill tasks at specified task locations; receiving an itinerary from a worker, the itinerary defining a journey the worker plans to take and including at least a starting point of the journey and an end point of the journey; automatically generating, based on the received itinerary, at least one parameterized, personlized action plan, the plan identifying a subset of the tasks for which requests had been received; and providing the plan to the worker.

### BACKGROUND

The present inventive subject matter relates generally to the art of crowdsourcing. Particular but not exclusive relevance is found in connection with mobile crowdsourcing. The present specification accordingly makes specific reference thereto at times. However, it is to be appreciated that aspects of the present inventive subject matter are also equally amenable to other like applications and/or environments.

In general, “crowdsourcing” is the practice of obtaining desired services, ideas, or content by soliciting contributions from a large group of people and especially from an online community rather than from traditional employees or suppliers. Computer systems and/or platforms (including servers and client applications) have been developed to help administer crowdsourcing initiatives in online and/or mobile environments. For example, commonly, an employer or other individual (i.e., a requestor) desiring the completion of a particular task, suitably posts, uploads and/or otherwise submits a task request to a crowdsourcing platform. The request may then be selectively obtained or accessed from the platform by another individual (i.e., a worker) that intends to fulfill the request and/or complete the requested task.

A significant distinction between mobile crowdsourcing platforms and online crowdsourcing platforms stems from the location-specific aspects of the tasks. In mobile crowdsourcing, workers are able to, and may in fact have to, physically travel to one or more locations specified in a task request in order to perform and/or complete the requested task. In this way, mobile crowdsourcing can leverage the spatial mobility of workers at different points in time.

Known mobile crowdsourcing platforms, e.g., such as Field Agent and Gigwalk, commonly have workers register with the platform after downloading a client application to their mobile device (e.g., a smartphone). Registered workers can then specify whether they would like to be notified of tasks close to their current locations or in the zip code used to create their profile. The platform then suggests (or “pushes”) to a potential worker those requested tasks which are to be executed in the vicinity of the worker's current location or in their designated zip code. A worker can then select (or “pull”) those tasks that they intend to perform, e.g., from a provided task list. Typically, the task request or task listing will includes details related to the task, e.g., such as a payment associated with fulfilling the task, a location where the task is to be executed (i.e., a task location), a description of the task and a straight-line distance from the worker's current location to the task location.

However, the onus remains on the worker to determine which tasks to select and in which order to sequence them. This is not a trivial problem. Moreover, conventional crowdsourcing platforms do not anticipate and/or account for a worker's intended future location when suggesting tasks thereto. That is to say, generally, conventional platforms merely suggest tasks near the work's current location or in the vicinity of another designated static region. Additionally, conventional platforms do not provide a sequenced set of tasks which optimize parameters such as travel efficiency and/or time efficiency. Also, current mobile crowdsourcing platforms can make things even more difficult by, for example, giving the straight-line distances from the current worker location to the task location as opposed to giving the driving distance.

Accordingly, a new and/or improved method, system and/or apparatus is disclosed for administering mobile crowdsourcing which addresses the above-referenced problem(s) and/or others.

### SUMMARY

This summary is provided to introduce concepts related to the present inventive subject matter. The summary is not intended to identify essential features of the claimed subject matter nor is it intended for use in determining or limiting the scope of the claimed subject matter. The embodiments described below are not intended to be exhaustive or to limit the invention to the precise forms disclosed in the following detailed description. Rather, the embodiments are chosen and described so that others skilled in the art may appreciate and understand the principles and practices of the present inventive subject matter.

In accordance with one embodiment, a method of administering mobile crowdsourcing is provided. The method includes: receiving a plurality of requests from requestors to fulfill tasks at specified task locations; receiving an itinerary from a worker, the itinerary defining a journey the worker plans to take and including at least a starting point of the journey and an end point of the journey; automatically generating, based on the received itinerary, at least one personalized action plan, the plan identifying a subset of the tasks for which requests had been received; and providing the plan to the worker.

In accordance with another embodiment, a computer system is provided for implementing the foregoing method.

Numerous advantages and benefits of the inventive subject matter disclosed herein will become apparent to those of ordinary skill in the art upon reading and understanding the present specification. It is to be understood, however, that the detailed description of the various embodiments and specific examples, while indicating preferred and/or other embodiments, are given by way of illustration and not limitation. Many changes and modifications within the scope of the present invention may be made without departing from the spirit thereof, and the invention includes all such modifications.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing selected elements of an exemplary mobile crowdsourcing platform incorporating one or more aspects of the present inventive subject matter.

FIG. 2 is a diagrammatic illustration showing an exemplary mobile end user device suitable for illustrating one or more aspects of the present inventive subject matter, said device showing on a display thereof an exemplary itinerary which may be submitted in accordance with one or more aspects of the present inventive subject matter.

FIG. 3 is a diagrammatic illustration showing the device of FIG. 2, said device prompting a worker for the input of optional additional constraints in accordance with one or more aspects of the present inventive subject matter.

FIG. 4 is a diagrammatic illustration showing the device of FIG. 2, said device outputting on its display a parameterized comparison listing of personalized action plans generated in accordance with aspects of the present inventive subject matter.

FIG. 5 is a diagrammatic illustration showing the device of FIG. 2, said device outputting on its display a graphical representation of one of the personalized action plans generated in accordance with aspects of the present inventive subject matter.

### DETAILED DESCRIPTION OF THE EMBODIMENT(S)

For clarity and simplicity, the present specification shall refer to structural and/or functional elements, relevant standards, algorithms and/or protocols, and other components, algorithms, methods and/or processes that are commonly known in the art without further detailed explanation as to their configuration or operation except to the extent they have been modified or altered in accordance with and/or to accommodate the preferred and/or other embodiment(s) presented herein. Moreover, the apparatuses and methods disclosed in the present specification are described in detail by way of examples and with reference to the figures. Unless otherwise specified, like numbers in the figures indicate references to the same, similar or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific materials, techniques, arrangements, etc. are either related to a specific example presented or are merely a general description of such a material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to the figures.

In general, there is disclosed herein a method and/or system which is operative to administer mobile crowdsourcing. It accommodates the submission of one or more task request, including particular constraints for the requested task, so that at any given time one or more task requests may be pending. Suitably, via a client application or the like running on a mobile end user device, a worker may enter and submit an itinerary along with additional optional constraints. The system and/or method generates a personalized action plan including a set of one or more sequenced task (e.g., selected from those pending) which satisfy the relevant constraints and fit nicely and/or near to a route defined by the itinerary. Suitably, the set of tasks included in the plan are selected to optimize (or nearly optimize) one or more desired parameters.

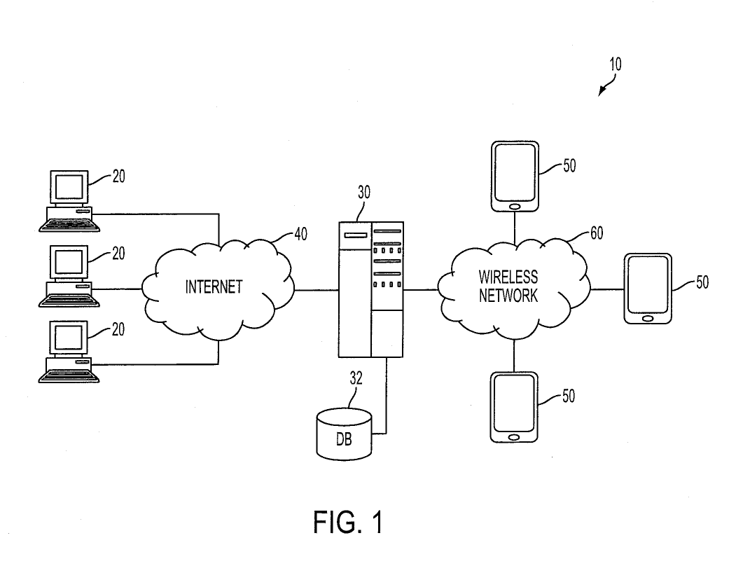

With reference now to FIG. 1, a mobile crowdsourcing platform 10 is suitably implemented via a computer system. As shown, one or more computers 20 are operatively connected to communicate with a platform server 30 via a suitable communication network 40, e.g., such as the Internet or otherwise. In practice, employers or other individuals (i.e., requestors) use the computers 20 to post, upload and/or otherwise submit requests for the fulfillment of desired tasks to the server 30. Generally, the platform 10 suitably permits one or more requestors to submit one or more requests so that at any given time one or more requests may be waiting to get fulfilled.

A task request submitted to the platform server 30 suitably includes particular details related to the task. For example, those details may be entered by the requestor via one of the computers 20 used to submit the request. Pending requests submitted to the platform server 30 are optionally maintained, along with their corresponding task details, in a request database (DB) 32 accessible by the platform server 30. In practice, the details for each task or task request may include, e.g., without limitation, one or more of the following: a task identifier that identifies the particular task; an identifier that identifies a requestor that submitted the associated task request; a payment amount associated with fulfilling the task; a location where the task is to be executed (i.e., a task location); a description of the task; one or more time constraints for executing the task (e.g., a time frame or time period in which the task is to be executed, a time by which the task has to be started, a deadline by which the task is to be completed, etc.); and an estimated amount of time it will take to complete the task.

The server 30 is also operatively connected to communicate with one or more mobile end user devices 50 (e.g., such as smartphones, wireless-enabled laptop computers or notepads, etc.) via a suitable wireless communication network 60, e.g., such as a Wi-Fi or cellular network or otherwise. In practice, a suitable program, software, code and/or client application is downloaded (e.g., from the platform server 30) and/or otherwise installed on the devices 50, and individuals employing the devices 50 register (e.g., with the platform server 30) to act as workers or potentials workers for selected tasks submitted to the platform server 30.

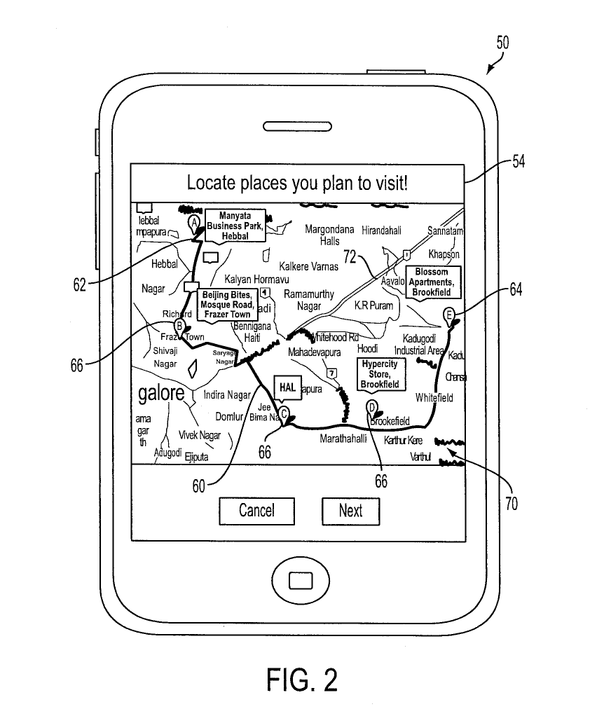

With reference now to FIG. 2, in practice, a worker uses the application running on their device 50 to plot, select and/or otherwise define a route 60, e.g., on a map 70. The route 60 suitably represents a worker's itinerary or a trip the worker plans to take, during which they may be willing to fulfill certain task requests pending on the platform 10. For example, the route 60 may be from a worker's place of employment to their home or vice versa. Suitably, the route 60 includes at least one starting point 62 and at least one end point 64. Additionally, the route 60 may include one or more stopovers 66 there along. For example, the stopovers 66 may include and/or represent a visit to a friend's home, a stop at a store or a stop at a gas station, etc. Suitably, the designated starting point 62, stopovers 66 (if any) and end point 64 define (at least partially) the route 60. In one suitable embodiment, the route 60 is plotted and/or follows along roadways 72 defined in the map 70. In practice, the worker may simply use the application running on the device 50 to set, define or otherwise enter desired waypoints and/or selected locations on the map 70 or otherwise to act as the respective starting point 62, stopovers 66 and end point 64. The route 60 may then be automatically calculated therefrom along selected roadways 72 on the map 70 so as to connected the starting point 62, any designated stopover 66 and the destination or end point 64, e.g., via a determined shortest physical distance and/or a determined shortest estimated travel time. Suitably, as shown, the route 60, starting point 62, stopovers 66 and end point 64 may be output on a display 54 of the device 50, e.g., overlaying the map 70 also output on the display 54.

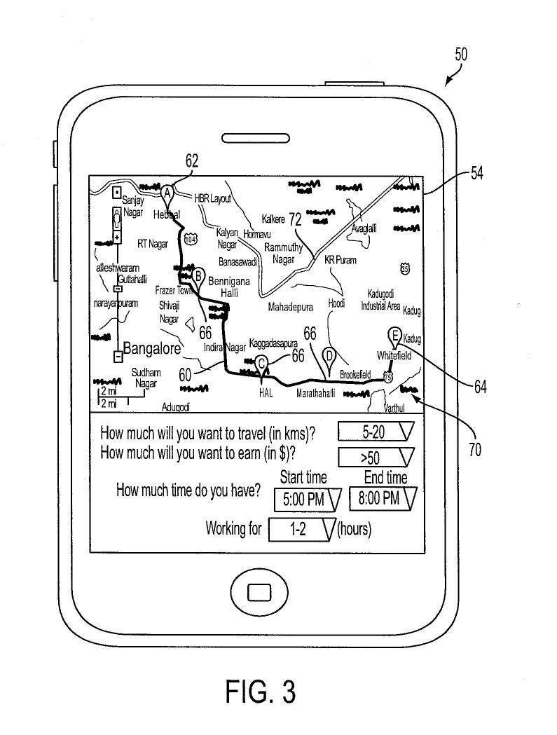

With reference now to FIG. 3, the application running on the device 50 may prompt the worker to enter and/or specify a set of additional constraints which the worker would like to have met in order for the worker to accept responsibility for completing one or more pending tasks during their planned trip. For example, the worker may be prompted to designate, without limitation: how far they are willing to travel; a payment amount they desire to earn for fulfilling one or more tasks; what types of task they are willing to perform; a time period in which they are willing to work to complete undertaken tasks; and a length of time during the specified time period that they are willing to devote to fulfilling one or more tasks. Specifically, in the illustrated example, the worker indicates that they a willing to travel between 5 to 20 kms, they desire to earn greater than $50.00; they are available to fulfill tasks between the hours of 5:00 PM to 8:00 PM; and they are willing to work for between 1 to 2 hours. Accordingly, the foregoing parameters along with the work's itinerary (i.e., starting point 62, ending point 64 and/or any stopovers 66) define the worker constraints for the planned trip or route 60.

In practice, the worker employs the application running on the worker's device 50 to upload, post and/or otherwise submit their itinerary (i.e., starting point 62, end point 64, any stopovers 66 and optionally the route 60), along with any selected or otherwise entered additional worker constraints, to the platform server 30. Optionally, the submitted itinerary may merely include the starting point 62, end point 64 and any chosen stopovers 66. In this case, the route 60 may be calculated and/or otherwise determined by the platform server 30.

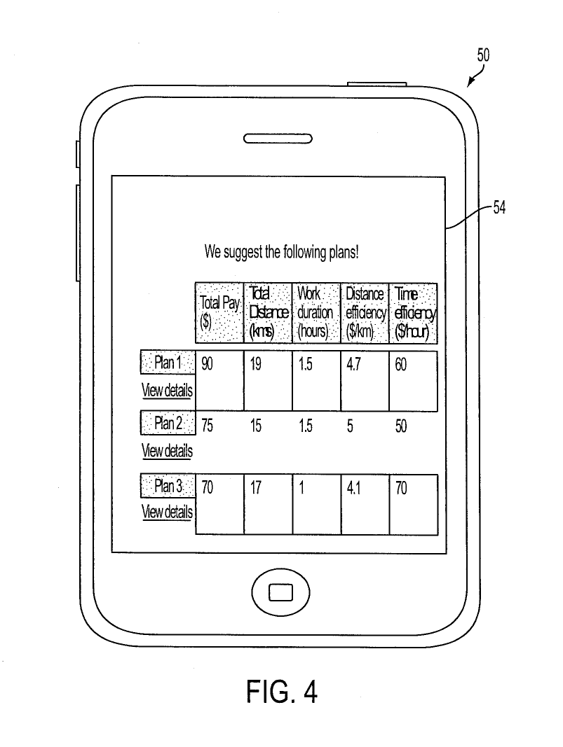

With reference now to FIG. 4, in response to receiving and/or based on the worker's submitted itinerary (including any associated additional constraints), the platform server 30 generates one or more personalized action plans. In practice, each action plan substantially satisfies the submitted worker constraints and includes a set of one or more selected pending task requests (e.g., maintained in the DB 32) that are suitably fitted to the submitted itinerary. For example, as shown in FIG. 4, three potential plans (i.e., Plan 1, Plan 2 and Plan 3) are generated. In practice, the generated plans and/or descriptions thereof are provided to the worker's device 50 running the client application which in turn outputs a listing of the plans on the display 54, e.g., as shown. Suitably, as shown, the description of each plan optionally includes, without limitation: the total pay or compensation earned for completing all the selected tasks in the plan (e.g., suitably this is tabulated and/or calculated from the corresponding payment amounts associated with each selected task request in the DB 32); a total distance a worker has to travel to complete all the tasks in the plan (e.g., this is suitably calculated and/or otherwise determined from the locations in the itinerary and the task locations); a total time estimated for completion of the tasks (e.g., this may be tabulated and/or calculated at least in part from the corresponding completion time estimates associated with each selected task request in the DB 32); a distance efficiency, which is a value representing the total compensation to be earned divided by the total distance to be traveled to complete all the tasks in the plan; and a time efficiency, which is a value representing the total compensation to be earned divided by the total estimated time which has to be devoted in order to complete all the tasks in the plan.

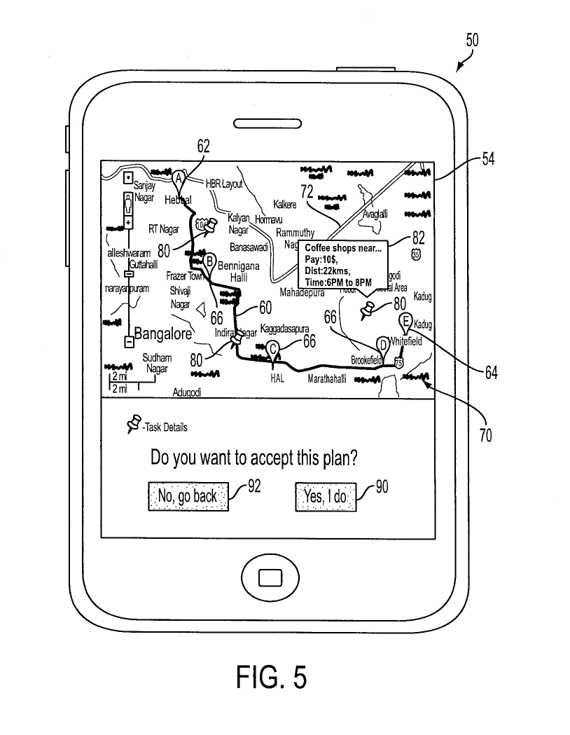

Upon selecting a generated plan or designed link (such as one of the illustrated “View details” links shown in FIG. 4) associated with one of the generated plans, the details of the particular generated plan are suitably output, e.g., on the display 54 of the device 50 running the client application. For example, as shown in FIG. 5, the output plan details may be depicted in a graphic format overlaying the map 70. That is to say, each task in the selected plan may be represented on the map 70 by a marker 80 positioned on the map 70 at the task location. Suitably, the itinerary (including the starting point 62, the ending point 64, any stopovers 66 and the route 60) may also be output overlaying the map 70. Upon selecting one of the individual tasks (e.g., by selecting, highlighting or hovering over the corresponding marker 80), specific details and/or information about that particular task (e.g., obtained from the DB 32) may be provided and/or output on the display 54, e.g., in the form of a popup balloon 82 or otherwise.

In one suitable embodiment, a modified route (e.g., following the roadways 72 of the map 70) is optionally calculated and/or otherwise determined which sequences the selected tasks of a given plan into the itinerary, e.g., so as to minimize (or nearly minimize) the overall travel distance and/or estimated traveling time. That is to say, the modified route begins at the starting point 62 and extends along the roadways 72 of the map 70 to the end point 64, while therebetween interconnecting and/or passing through in sequence order any designated stopovers 66 and/or selected task locations of the plan (e.g., indicated by the markers 80). Optionally, the modified route may also be output on the display 54 overlaying the map 70. Suitably, the modified route may be determined by the platform server 30 and forwarded to the device 50 running the client application, or it may be determined by the device 50 and/or the client application running thereon. In either case, notably, the automatically generated personalized plan removes an onus from the worker of having to select individual tasks and fit them optimally and/or nicely into their itinerary while meeting other of their desired criteria (i.e., total compensation, total time devotion, etc.). Significantly, the selected tasks for a given plan are chosen and sequenced to lie within a nice and/or otherwise specified or determined proximity along a designated travel path of the worker, as opposed to merely a current location of the worker or an otherwise set static location or region.

As shown, buttons or links 90 and 92 (or the like) may also be presented on the display 54 allowing the worker to ultimately accept the action plan selected or alternatively allowing the worker, e.g., to return to the list of the various generated plans (e.g., as shown in FIG. 4).

The generation of a personalized action plan for a given itinerary and accompanying set of worker constraints may be achieve via execution of a suitable method, process and/or algorithm, e.g., by the platform server 30. One suitable such process and/or algorithm shall now be discussed. For purposes of the present example, the following possible worker constraints shall be consider, which can be (optionally) provided to the platform:
a starting point pₛₜₐᵣₜ and an end point p_{end} (without loss of generality, there may also be in practice one or more stopover points p₁, . . . pₙ in between the foregoing terminal points, however, the core of the algorithm remains essentially the same in any event, so for the purposes of clarity and simplicity herein, the present example will primarily focus on a case where there are no stopovers);
a minimum per task payment payₘᵢₙ the worker is willing to work for;
one or more task types, represented by the set of task types K, that the worker is willing to perform, where K may be a subset of Q which includes all potential task types;
a time frame H_{w} (e.g., expressed in days and/or hours) in which the worker is available to work;
a maximum total distance Dₘₐₓ the worker is willing to travel; and
a maximum total time Tₘₐₓ the worker is willing to work.

Similarly, the present example shall consider the following requestor constraints which can be (optionally) provided to the platform:
a minimum experience and/or accuracy ranking expₘᵢₙ of a worker; and
a time frame Hᵣ (e.g., expressed in days and/or hours) in which the task is available for completion.

It is to be appreciated that the foregoing are not exhaustive lists of optional constraints. However, they do suffice for illustrating some of the technical difficulties to be overcome in constructing or generating an appropriate plan for a worker.

In accordance with suitable embodiments, the plan generating algorithm accounts for the particular efficiency or other parameter that the worker wishes to optimize. For example, in one case, the optimized parameter may be the total compensation or payment P the worker earns for completing all the tasks in the generated plan, or potentially the worker may desire to optimize their distance efficiency E_{D}=P/D or temporal efficiency E_{T}=P/T which is the total compensation or pay earned for completion of all the tasks in the plan normalized by the total physical distance traveled D to complete the plan tasks or total amount of time T spent to complete the plan tasks, respectively.

Suitably, the platform 10 or platform server 30 employs a robust and efficient plan-generating and/or route-suggesting process and/or algorithm that determines and/or proposes, within the worker and requestor constraints, one or more potential sequences of tasks (i.e., personalized action plans) to the worker. In one suitable embodiment, graph theory is employed to solve the problem. More specifically, an initial graph is defined and successively refined, e.g., via the worker and/or requestor constraints. Then, an algorithm is employed to act on the final refined graph in order to select those tasks which are to be included in the plan.

In general, one suitable approach can be described as follows. Let G be a complete directed graph (including vertexes v and edges e) where the vertexes v thereof represent the pending task requests submitted to the platform 10. Let G′ be G augmented by {vₛₜₐᵣₜ, v_{end}}, where vₛₜₐᵣₜ is a vertex representing pₛₜₐᵣₜ and v_{end} is a vertex representing p_{end}, and where there is an edge e from vₛₜₐᵣₜ to every vertex in G and from every vertex in G to v_{end}. Suitably, any given edge e in G′ may have one or more weights applied to and/or associated therewith, e.g., such as the physical roadway distance d(e) represented between any two vertexes, the expected travel time t(e) represented between any two vertexes, etc. Having so defined G′, the goal is to find one (or more) paths along the edges e from vₛₜₐᵣₜ to v_{end} that include one (or more) tasks represented by vertexes v along the way, and satisfy both the worker and requestor constraints.

Suitably, to simplify and/or expedite processing, the graph G′ is initially refined in accordance with selected worker and/or requestor constraints. For example, this can be accomplished by modifying the graph G′ as follows:
remove all vertices representing tasks where designated payment amount is less than payₘᵢₙ;
remove all vertices representing a task identified as a task type not in K;
remove all vertices representing tasks associated with a minimum worker experience/accuracy ranking expₘᵢₙ higher than that of the worker in question; and
remove all vertices representing tasks wherein the intersection of Hᵣ and H_{w} is empty, i.e., remove those vertexes for tasks where the time frame in which the worker is willing to work is not compatible with the time frame in which the task is requested to be completed.

By eliminating vertexes in this manner, further processing is simplified and/or expedited insomuch the number of potential paths along the edges e within G′ from vₛₜₐᵣₜ to v_{end} that have to be searched and/or analyzed is now reduced. Optionally, still other constraints are use to cut down the search space. For example:
G′ may in effect be overlaid on a map (e.g., such as the map 70), and using pₛₜₐᵣₜ and p_{end} as foci, a ellipse defined such that that sum of the physical distances to each foci is at most Dₘₐₓ; then all vertices representing task locations that fall outside this ellipse may be removed.
Similarly, in G′, the various vertexes representing tasks have associated therewith estimate task completion times, accordingly, the foregoing may be essentially repeated with the ellipse defined such that the sum of the times to the foci is at most Tₘₐₓ; then again all vertexes representing task .outside the defined ellipse may be removed.

It may be worth noting that the foregoing processing does not, in and of itself, guarantee the satisfaction of the distance or time constraints for any path, but rather it removes those vertices that a solution which does satisfy the constraints cannot include. Suitably, the graph is ultimately refined and/or constrained as discussed above. For nominal purposes herein, it suffices to let such a graph be referred to as G″.

In one suitable embodiment, the processing is now aimed at searching for and/or finding a path (or set of paths) from vₛₜₐᵣₜ to v_{end} in G″ through one or more vertexes that optimize the desired parameter, e.g., distance efficiency E_{D} or temporal efficiency E_{T} or total payment P, while staying within any remaining constraints. However, in graph theory, this reduces to a longest path problem, which is generally NP complete. Nevertheless, since G″ has already been significantly constrained, and particularly in the cases where pₛₜₐᵣₜ and p_{end} and G are largely static, the solution can be pre-computed relatively effectively. For example, one such practical situation would be where the pending tasks rarely change (e.g., checking rack or shelf space stores) and a worker seeks tasks along a route they regularly take, e.g., between work and home.

However, in the case that either the tasks or the worker's preferences and/or itinerary are relatively dynamic, or the tasks are very dense, an effective algorithm is suitably employed to compute or determine the solution(s) on the fly. Notably, the longest path problem is polynomial-time solvable in the case that the graph G″ is a directed acyclic graph (DAG). In practice, one could of course go from any vertex on the graph to any other vertex. However, it is postulated herein that the most efficient routes will not have a worker travel back and forth between locations, or digress far from their initial itinerary route (e.g., route 60). In fact, it may be generally deemed advisable to make some kind of progress in each leg from pₛₜₐᵣₜ towards p_{end} Hence, in one suitable embodiment, each edge in G″ is oriented in such a way that it points towards v_{end} and away from vₛₜₐᵣₜ (in either distance or time space, depending on which is to optimize). Note that by definition, no cycle exists. Hence, a polynomial time longest path algorithm that operates on DAGs may now be used. For example, a standard algorithm can optionally be used (throwing out any paths found that do not meet worker or requestor constraints) to give an ordered list of the top n tasks to include in a generated plan. Optionally, this can be done for several types of efficiency (or convex combinations thereof), and the worker can be given the option to sort by several such parameters.

The above methods, system, platforms, processes, algorithms and/or apparatus have been described with respect to particular embodiments. It is to be appreciated, however, that certain modifications and/or alteration are also contemplated.

In any event, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that any one or more of the particular tasks, steps, processes, methods, functions, elements and/or components described herein may suitably be implemented via hardware, software, firmware or a combination thereof. In particular, the platform 10, computers 20, server 30 and/or user devices 50 may be embodied by computers or other electronic data processing devices that are configured and/or otherwise provisioned to perform one or more of the tasks, steps, processes, methods and/or functions described herein. For example, a computer or other electronic data processing device embodying a particular element may be provided, supplied and/or programmed with a suitable listing of code (e.g., such as source code, interpretive code, object code, directly executable code, and so forth) or other like instructions or software or firmware, such that when run and/or executed by the computer or other electronic data processing device one or more of the tasks, steps, processes, methods and/or functions described herein are completed or otherwise performed. Suitably, the listing of code or other like instructions or software or firmware is implemented as and/or recorded, stored, contained or included in and/or on a non-transitory computer and/or machine readable storage medium or media so as to be providable to and/or executable by the computer or other electronic data processing device. For example, suitable storage mediums and/or media can include but are not limited to: floppy disks, flexible disks, hard disks, magnetic tape, or any other magnetic storage medium or media, CD-ROM, DVD, optical disks, or any other optical medium or media, a RAM, a ROM, a PROM, an EPROM, a FLASH-EPROM, or other memory or chip or cartridge, or any other tangible medium or media from which a computer or machine or electronic data processing device can read and use. In essence, as used herein, non-transitory computer-readable and/or machine-readable mediums and/or media comprise all computer-readable and/or machine-readable mediums and/or media except for a transitory, propagating signal.

Optionally, any one or more of the particular tasks, steps, processes, methods, functions, elements and/or components described herein may be implemented on and/or embodiment in one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the respective tasks, steps, processes, methods and/or functions described herein can be used.

Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of administering mobile crowdsourcing, said method comprising:
receiving a plurality of requests from requestors to fulfill tasks at specified task locations;
receiving an itinerary from a worker, said itinerary defining a journey the worker plans to take and including at least a starting point of the journey and an end point of the journey;
automatically generating, based on the received itinerary, at least one personalized action plan, said plan identifying a subset of the tasks for which requests had been received; and
providing the plan to the worker.

2. The method of claim 1, wherein the identified subset includes a plurality of the tasks for which requests had been received, and said generating includes:
determining a sequence in which the plurality of tasks included in the subset should be fulfilled, said sequence being identified in the plan.

3. The method of claim 1, wherein the received requests are accompanied by additional requestor constraints and the itinerary is accompanied by additional worker constraints, and said generating includes:
baring from the subset those tasks which are not compatible with the requestor constraints and the worker constraints.

4. The method of claim 1, wherein said requests are received from the requestors over a first communication network, said plans are provided to the worker over a second communication network, and said generating is executed by a computer operatively coupled to the first and second communication networks.

5. The method of claim 4, wherein the second communication network is a wireless communication network.

6. The method of claim 2, wherein said generating includes determining a route over roadways of a map between the starting point and the end point, such that therebetween the route passes through the task locations of those tasks included in the subset in the determined sequence.

7. The method of claim 6, wherein each task is associated with a compensation amount that is earned upon fulfillment of the task and said route is determined so as to optimize a travel efficiency value, said travel efficiency value being a ratio of a sum of the associated compensation amounts for the tasks included in the subset to a length of the route.

8. The method of claim 6, wherein each task is associated with a compensation amount that is earned upon fulfillment of the task and an estimated completion time for fulfilling the task and tasks are selected for inclusion in the subset so as to optimize a time efficiency value, said time efficiency value being a ratio of a sum of the associated compensation amounts for the tasks included in the subset to a sum of the estimated completion times for the task included in the subset.

9. The method of claim 1, wherein the itinerary includes at least one stopover that the worker intends on visiting along their journey from the starting point to the end point.

10. The method of claim 1, wherein said generating comprises:
defining a complete directed graph, wherein vertexes of the graph represent tasks for which requests have been received; and
augmenting the graph with: (i) vertexes representing the starting point and the end point; (ii) edges extending from the vertex representing the starting to every vertex representing a task; and (iii) edges extending from every vertex representing a task to the vertex representing the end point.

11. The method of claim 10, wherein said generating further comprises:
refining the augmented graph by removing vertexes therefrom which are not compatible with: constraints imposed by the requestor; constraints imposed by the worker; or constraints imposed as a result of the itinerary.

12. The method of claim 11, wherein said generating further comprises:
orienting each edge within the refined graph such that it points toward the vertex representing the end point and away from the vertex representing the starting point in at least one of a time space or a distance space.

13. The method of claim 12, wherein said generating further comprises:
applying a polynomial time longest path algorithm that operates on directed acyclic graphs to the edge oriented refined graph.

14. A computer system for implementing the method of claim 1.
